(19) United States
(12) Patent Application Publication
(10) Pub. No.: US 2002/0178890 A1
(43) Pub. Date: Dec. 5, 2002

(54) Cutting tool

(76) Inventors: Yukio Okuda, Tokyo (JP); Hirokazu Matsumoto, Tokyo (JP)

Correspondence Address: SMITH, GAMBRELL & RUSSELL, LLP, 1850 M Street, N.W. (Suite 800), Washington, DC, 20036, US

(21) Appl. No.: 09/837,617

(22) Filed: Apr. 19, 2001

(51) Int. Cl. B23D 57/00

(52) U.S. Cl. 83/835; 83/665

(57) ABSTRACT

A cutting tool is composed of a circular base plate, and a plurality of arc-shaped cutting tips fixed to the outer peripheral surface of the base plate and spaced from each other in a circumferential direction. The base plate is formed from stainless steel.

### FIELD OF THE INVENTION

This invention relates to a cutting tool used to cut a hard-to-cut material such as a cast iron tube.

### DESCRIPTION OF THE PRIOR ART

A cutting tool to be rotated at a high speed is used for cutting a hard-to-cut material such as a cast iron tube. A typical example of such a cutting tool is a cutting tool called a segmental circular saw. Such a cutting tool is composed of a circular base plate, and a plurality of cutting tips fixed to the outer peripheral surface of the base plate and spaced from each other in the circumferential direction. Normally, a plurality of slits extending radially inwardly from the outer peripheral surface of the base plate are formed in the base plate, and the cutting tips are arranged between the slits.

According to the prevent inventors' experience, conventional cutting tools pose the problem that the cutting tips do not wear badly and are still usable, but cracks extending from the slits occur in the base plate in relatively short periods, with the result that the cutting tools become unusable. Nor are their cutting speeds fully satisfactory.

### SUMMARY OF THE INVENTION

A principal object of the present invention is to improve a cutting tool used to cut a hard-to-cut material such as a cast iron tube, thereby prolonging its life markedly and increasing its cutting speed remarkably.

The base plate of the conventional cutting tool has been formed from alloy steel, such as chromium molybdenum steel, for such reasons as high hardness. The inventors have conducted extensive studies, and have found, to their surprise, that when the base plate is formed from stainless steel, the life of the cutting tool can be markedly prolonged, and its cutting speed can be markedly increased. It is not fully clear why the formation of the base plate from stainless steel results in an extended life and an increased cutting speed. However, the inventors speculate that the high toughness of stainless steel may be a reason behind these advantages.

As a cutting tool for attaining the above principal object, the present invention provides a cutting tool composed of a circular base plate, and a plurality of arc-shaped cutting tips fixed to the outer peripheral surface of the circular base plate and spaced from each other in the circumferential direction, wherein the base plate is formed from stainless steel.

A particularly preferred example of the stainless steel is SUS410 stainless steel. In a preferred embodiment, the cutting tips are formed by bonding diamond grains with a metal bond. The metal bond preferably contains 60 wt. % or more of copper and 10 wt. % or more of tin, and particularly, contains 20 wt. % or more of cobalt as well as 60 wt. % or more of copper and 10 wt. % or more of tin. The cutting tips may be formed by being integrally sintered on a copper side surface of a copper-nickel laminate material formed by hot rolling copper and nickel, and a nickel side surface of the laminate material may be fused to the outer peripheral surface of the base plate. A plurality of slits extending radially inwardly from the outer peripheral surface of the base plate may be formed in the base plate, and the cutting tips may be arranged between the slits. Preferably, an electrodeposited layer of abrasive grains is formed on each side surface of the base plate.

### BRIEF DESCRIPTION OF THE DRAWINGS

FIG. 1 is a front view showing a preferred embodiment of a cutting tool constituted in accordance with the present invention;

FIG. 2 is an enlarged partial front view of the cutting tool of FIG. 1; and

FIG. 3 is an enlarged partial sectional view of the cutting tool of FIG. 1.

### DETAILED DESCRIPTION OF THE PREFERRED EMBODIMENTS

Preferred embodiments of a cutting tool constituted in accordance with the present invention will now be described in detail with reference to the accompanying drawings.

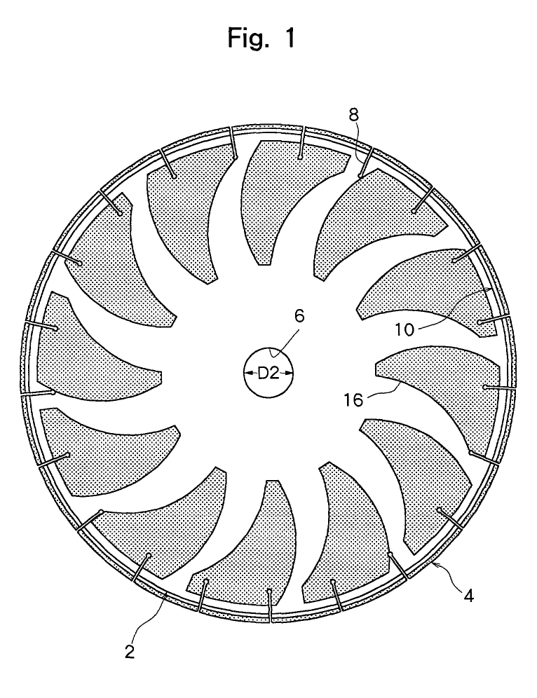

Referring to FIGS. 1 to 3, the cutting tool constituted in accordance with the present invention is composed of a base plate 2, and a plurality of (21 in the illustrated embodiment) cutting tips 4 fixed to the base plate.

The base plate 2 is in the form of a thin-walled disk, and a circular mounting hole 6 is formed at the center. A plurality of (21 in the illustrated embodiment) slits 8 extending radially inwardly at intervals in the circumferential direction are formed in a peripheral edge portion of the base plate 2. The inside end of the slit 8 is advantageously in the form of a small circle. In more detail, each of the slits 8 can be formed advantageously by boring a small circular hole at the inside end thereof, and then grooving the base plate 2 up to the small circular hole. In the cutting tool constituted in accordance with the present invention, it is important that the base plate 2 be formed from stainless steel. SUS410 can be cited as a particularly preferred stainless steel. When the outer diameter of the base plate 2 is about 250 to 350 mm, the thickness of the base plate 2 is preferably about 1.5 to 2.5 mm.

Each of the cutting tips 4 is preferably formed by bonding diamond grains with a metal bond. The diamond grains may have grain sizes of 400 to 500 μm, and the volume ratio of the diamond grains in the cutting tip 4 may be from about 8.00 to 9.50% (concentration: from 32 to 38). The metal bond preferably contains copper and tin, especially, 60 wt. % or more of copper and 10 wt. % or more of tin. Particularly preferred is a metal bond containing 20 wt. % or more of cobalt in addition to 60 wt. % or more of copper and 10 wt. % or more of tin.

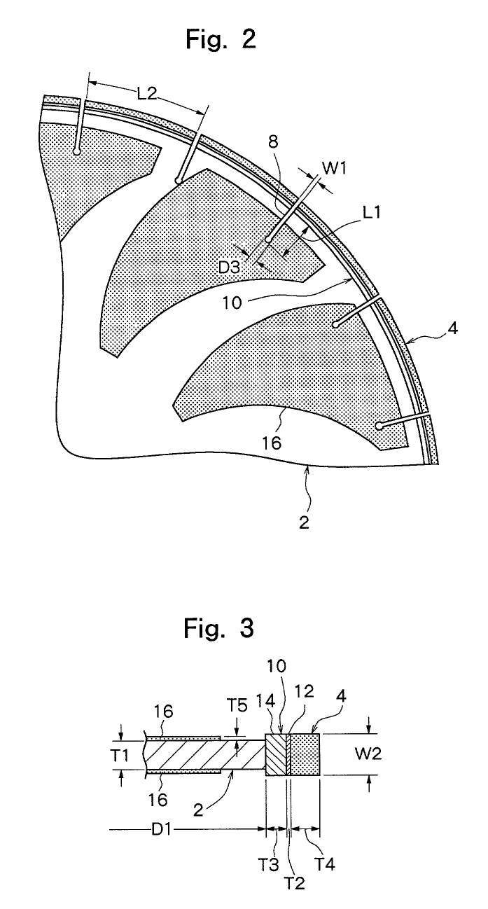

As clearly shown in FIGS. 2 and 3, each of the cutting tips 4 in the illustrated embodiment is formed in an arcuate shape conforming to the outer periphery of the base plate 2. The cutting tips 4 are fixed, via laminate materials (claddings) 10, to the outer peripheral surface of the base plate 2 and spaced from each other in the circumferential direction, and extend in the circumferential direction between the slits 8. Each of the laminate materials 10 is similarly in the form of an arc conforming to the outer periphery of the base plate 2. The cross sectional shapes of the cutting tip 4 and the laminate material 10 may be rectangular, and the widths of the cutting tip 4 and the laminate material 10 are substantially the same as each other, but somewhat larger than the thickness of the base plate 2. When the thickness of the base plate 2 is 1.5 to 2.5 mm, the widths of the cutting tip 4 and the laminate material 10 may be about 2.5 to 3.5 mm. The cutting tip 4 constituted with the use of the above-mentioned metal bond cannot be directly fixed, sufficiently firmly, to the base plate 2 formed from stainless steel. Thus, the laminate material 10 is interposed between the cutting tip 4 and the base plate 2. It is important for the laminate material 10 to have a material layer capable of being sufficiently firmly fixed to the cutting tip 4, and a material layer capable of being sufficiently firmly fixed to the base plate 2. The laminate material 10 in the illustrate embodiment is a copper-nickel laminate material formed by hot rolling copper 12 and nickel 14. The layer thickness of the copper 12 may be about 0.2 to 0.4 mm, while the thickness of the nickel 14 may be about 1.0 to 1.5 mm.

In a preferred embodiment, the laminate material 10 and the cutting tip 4 are fixed to each other sufficiently firmly by directly sintering the cutting tip 4 on the copper 12 of the laminate material 10. In greater detail, it is preferred to mix diamond grains with a metal powder constituting the metal bond (preferably, a copper powder, a tin powder and a cobalt powder), placing the mixture in a required shape on the copper 12 of the copper-nickel laminate material 10, and sintering the mixture as the cutting tip 4. In a typical example of sintering, sintering is performed for 60 minutes at a temperature of 775° C. and a pressure of 250 kg/cm² in an atmosphere of hydrogen. The laminate material 10, having the cutting tip 4 integrally formed on the copper 12, can be advantageously fixed to the base plate 2 by fusing the nickel 14 of the laminate material 10 to the base plate 2 by use of a laser beam.

With reference to FIGS. 1 to 3, the base plate 2 preferably further has an abrasive grain electrodeposited layer 16 disposed on each of the side surfaces thereof. In the illustrated embodiment, the abrasive grain electrodeposited layer 16 is formed in each of 12 regions arranged with some spacing in the circumferential direction on each of the side surfaces of the base plate 2. The respective abrasive grain electrodeposited layers 16 have substantially the same shape, forming a nearly paisley pattern extending radially inwardly from the peripheral edge portion of the base plate 2. These abrasive grain electrodeposited layers 16 can be formed by electrodepositing suitable abrasive grains, such as silicon carbide, by a well known electroplating method. The particle size of the abrasive grains to be electrodeposited may be 100 to 120 μm. A metal for electroplating may be nickel. The thickness of the abrasive grain electrodeposited layer 16 is preferably 150 to 250 μm. The total area of the regions where the abrasive grain electrodeposited layers 16 are formed may be about 10 to 50% of each side surface of the base plate 2.

### EXAMPLES 1 TO 5

There were produced five cutting tools of the same shape as shown in FIGS. 1 to 3, except that no abrasive grain electrodeposited layers were formed on the side surfaces of the base plate. The base plate was formed from SUS410 stainless steel, and had an outer diameter Dl of 297 mm, a thickness T1 of 2.0 mm, and a mounting hole diameter D2 of 30 mm. Twenty-one slits were formed in a peripheral edge portion of the base plate at equal intervals in the circumferential direction. The width W1 of the slit was 1.5 mm, the length L1 of the slit was 7 mm, and the diameter D3 of the radially inside small circular shape of the slit was 1.7 mm. The laminate material was a copper-nickel laminate material comprising a copper layer and a nickel layer laminated by hot rolling. The thickness T2 of the copper layer was 0.3 mm, while the thickness of the nickel layer was 1.2 mm. The cutting tip was formed by integrally sintering its materials on the copper of the laminate material. The particle size of the diamond grains in the cutting tip was 400 to 500 μm, and the volume ratio of the diamond grains was 8.75% (concentration: 35). The metal bond contained 65 wt. % of copper, 13 wt. % of tin, and 22 wt. % of cobalt. The sintering was performed for 60 minutes at a temperature of 775° C. and a pressure of 250 kg/cm² in an atmosphere of hydrogen. The thickness T4 of the cutting tip was 2 mm, the circumferential length L2 of the cutting tip was 43 mm, and the width W2 of the cutting tip was 3.0 mm.

The above-described cutting tool was mounted on an engine cutter (power: 3.5 KW, revolution speed: 5,000 rpm) marketed under the trade name “K650 Active” by Electrolux (Japan) Limited, and a cast iron tube cutting test was conducted. The cast iron tube is sold under the trade name “Kubota Ductile Tube Resin Type” by Kubota, Ltd. This cast iron tube had an outer diameter of 159 mm, and an inner diameter of 144 mm, had an inner peripheral surface with a resin coating, and had a cast iron portion wall thickness of 7.5 mm. With the cast iron tube being rotated at a peripheral speed of 1.15 cm/second, the engine cutter was manually moved to feed the cutting tool, thereby cutting the cast iron tube completely. Each of the five cutting tools was used repeatedly for cutting of the cast iron tube. Cracks extending from the slits occurred in the base plate at a time when the number of cuttings shown in Table 1 took place. As a result, the cutting tools became no more usable. Moreover, each of the five cutting tools was measured ten times for how many seconds the cutting tool took to cut the cast iron tube completely. The results are shown in Table 1.

### COMPARATIVE EXAMPLES 1 TO 5

Five cutting tools were produced in the same manner as in Examples 1 to 5, except that the base plate was formed from SCM435 chromium molybdenum steel. The same cutting test was conducted. The results are shown in Table 1.

### EXAMPLE 6 TO 10

Five cutting tools were produced in the same manner as in Examples 1 to 5, except that an abrasive grain electrodeposited layer in a configuration as shown in FIGS. 1 to 3 was disposed on each of the side surfaces of the base plate. The abrasive grain electrodeposited layer was formed by electrodepositing silicon carbide particles with a particle size of 100 to 120 μm with the use of nickel as a metal for electroplating. The thickness T5 of the abrasive grain electrodeposited layer was 200 μm, and the volume ratio of the abrasive grains was 37.5 (concentration: 150). The same cutting test as in Examples 1 to 5 was conducted. The results are shown in Table 1.

TABLE 1

| | Life | Cutting speed (seconds) | | |
|---|---|---|---|---|
| | (no. of cuttings) | Maximum | Minimum | Average |
| Ex. 1 | 1463 | 28 | 50 | 46 |
| Ex. 2 | 1497 | 30 | 48 | 44 |
| Ex. 3 | 1471 | 31 | 51 | 48 |
| Ex. 4 | 1452 | 32 | 48 | 43 |
| Ex. 5 | 1517 | 34 | 46 | 45 |
| Comp. Ex. 1 | 600 | 38 | 60 | 50 |
| Comp. Ex. 2 | 862 | 40 | 64 | 53 |
| Comp. Ex. 3 | 953 | 37 | 63 | 56 |
| Comp. Ex. 4 | 701 | 42 | 62 | 51 |
| Comp. Ex. 5 | 539 | 43 | 65 | 55 |
| Ex. 6 | 1521 | 27 | 42 | 40 |
| Ex. 7 | 1482 | 28 | 44 | 42 |
| Ex. 8 | 1587 | 26 | 43 | 41 |
| Ex. 9 | 1565 | 29 | 45 | 43 |
| Ex. 10 | 1600 | 32 | 42 | 40 |

What we claim is:

1. A cutting tool comprising a circular base plate, and a plurality of arc-shaped cutting tips fixed to an outer peripheral surface of the circular base plate and spaced from each other in a circumferential direction, wherein the base plate is formed from stainless steel.

2. The cutting tool of claim 1, wherein the base plate is formed from SUS410 stainless steel.

3. The cutting tool of claim 1, wherein the cutting tips are formed by bonding diamond grains with a metal bond, and the metal bond contains copper and tin.

4. The cutting tool of claim 3, wherein the metal bond contains 60 wt. % or more of copper and 10 wt. % or more of tin.

5. The cutting tool of claim 4, wherein the metal bond contains 20 wt. % or more of cobalt.

6. The cutting tool of claim 3, wherein the cutting tips are formed by being integrally sintered on a copper side surface of a copper-nickel laminate material formed by hot rolling copper and nickel, and a nickel side surface of the laminate material is fused to the outer peripheral surface of the base plate.

7. The cutting tool of claim 1, wherein a plurality of slits extending radially inwardly from the outer peripheral surface of the base plate are formed in the base plate, and the cutting tips are arranged between the slits.

8. The cutting tool of claim 1, wherein an electrodeposited layer of abrasive grains is formed on each of side surfaces of the base plate.
